(19) United States
(12) Patent Application Publication
(10) Pub. No.: US 2009/0213445 A1
(43) Pub. Date: Aug. 27, 2009

(54) Optical scanning device and optical reading system provided with the optical scanning device

(75) Inventor: Akifumi Kabeya, Sagamihara-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/072,204

(22) Filed: Feb. 25, 2008

(51) Int. Cl. G02B 26/10

(52) U.S. Cl. 359/198.1

(57) ABSTRACT

An optical scanning device according to an embodiment of the present invention has a support spring composed of S-shaped leaf springs. The support spring is bent at the middle, providing an L-shaped spring, which is composed of two independently working components. One component dominantly biases the scanning mirror body. The other component dominantly swings the scanning mirror body. So configured, the support spring restricts a motion of the shaft around which the scanning mirror body swings, and biases the scanning mirror body onto the shaft and inhibits the body from moving in the axial direction of the shaft.

### BACKGROUND OF THE INVENTION

1. Field of the Invention

The present invention relates to an optical scanning device for use in an optical symbol reading system, a representative example of which is the barcode reader, and designed to deflect repeatedly a laser beam to scan optical symbols, and also to an optical reading system that incorporates such an optical scanning device.

2. Description of the Related Art

Optical symbol reading systems (hereinafter referred to as optical reading apparatuses), such as barcode readers, which scan a symbol mark, such as a barcode, with a laser beam, thereby reading information from the symbol, are generally known.

An optical reading system of this type has an optical scanning mechanism that applies a laser beam emitted from a light source such as a semiconductor laser to a barcode, while repeatedly deflecting the laser beam in a one-dimensional direction or a two-dimensional direction. The barcode reflects laser beam. The light reflected from the barcode passes through a condensing lens and reaches a photodetector such as a photodiode. The photodetector generates an electric signal from the reflected light. The barcode is decoded based on the electric signal output from the photodetector.

Known as conventional optical scanning mechanism is one that has a polygon mirror or a swing mirror. The swing mirror of an optical scanning mechanism receives a laser beam emitted from a light source, while it is swinging. The swing mirror reflects the laser beam, which travels to a barcode. As the mirror swings, the barcode is repeatedly scanned with the beam at a constant frequency.

A mechanism that swings a swing mirror is proposed in, for example, Jpn. Pat. Appln. KOKAI Publication No. 2003-315722. This publication discloses an optical unit comprising a mirror-swinging mechanism. This optical unit has a rotor, an electromagnetic coil, a condensing lens, and a photodetector. The rotor has a light source and a mirror, which are mounted on a base. The electromagnetic coil serves as drive source for swinging the mirror. The condensing lens receives light reflected from a barcode.

The rotor has a through hole (bearing hole). A bearing is fitted in this hole and rotatably mounted on a shaft that is secured to the base. The bearing hole has a diameter a little larger than the diameter of the shaft. This allows the rotor to swing around the shaft. To that side of the rotor, which faces away from the mirror, a coil spring is secured, biasing the shaft onto the circumferential surface of the bearing hole. The rotor is therefore prevented from vibrating when it rotates.

A permanent magnet is provided on one side of the rotor. On the other side of the rotor, a balancer is provided, which is as heavy as the permanent magnet. Near the permanent magnet, the electromagnetic coil is arranged. The electromagnetic coil generates an alternating field. The alternating field induces an electromagnetic force between the electromagnetic coil and the permanent magnet. As a result, the rotor swings because of its inertial moment and the tension of the coil spring.

The mirror-swinging mechanism incorporated in the optical reading apparatus described above should be small and light and should be manufactured at low cost. It is also desired that the mirror stably and smoothly swing, without vibrating.

In order to achieve stable swinging of the mirror, three requirements must be accomplished. First, the rotor, including the mirror, should be held at a prescribed angle (or, at a neutral position). Second, the motion (swing) of the rotor, in the direction along the shaft, should be minimized. Third, the motion of the rotor in the radial direction of the shaft (i.e., motion of the rotor axis) should be minimized.

### BRIEF SUMMARY OF THE INVENTION

An embodiment of the present invention provides an optical scanning device which can be small and light and can be manufactured at low cost and in which unnecessary motion is eliminated when the mirror swings, thereby stably and reliably scanning an object with a laser beam. Another embodiment of the present invention can provide an optical reading system that incorporates such an optical scanning device.

More precisely, the first-mentioned embodiment provides an optical scanning device which comprises: a scanning mirror which has a plane mirror configured to reflect an incident light beam and direct the light beam toward an object existing in front of the device, and a concave mirror configured to receive and condense the light beam reflected by the object; a scanning mirror body which holds the scanning mirror and which is mounted on a shaft implanted in a base; a drive mechanism which swings the scanning mirror body around the shaft; and a support spring which is secured, at one end, to a back of the scanning mirror body and, at the other end, to a fastening member implanted in the base and which has a plurality of bent parts, each shaped like a plate and having a surface intersecting at right angles with a direction in which the scanning mirror body swings.

More precisely, the other embodiment provides an optical reading system which comprises: a light source which emits a light beam; a deflecting mirror which deflects the light beam emitted from the light source; an optical scanning device which keeps swinging and directing the light toward an object, thereby scanning the object with the light beam, and which receives and condenses the light beam reflected by the object; and an optical detecting unit which receives the reflected light condensed by the optical scanning device. The optical scanning device has: a scanning mirror which has a plane mirror configured to reflect an incident light beam and direct the light beam toward an object existing in front of the device, and a concave mirror configured to receive and condense the light beam reflected by the object; a scanning mirror body which holds the scanning mirror and which is mounted on a shaft implanted in a base; a drive mechanism which swings the scanning mirror body around the shaft; and a support spring which is secured, at one end, to a back of the scanning mirror body and, at the other end, to a fastening member implanted in the base and which has a plurality of bent parts, each shaped like a plate and having a surface intersecting at right angles with a direction in which the scanning mirror body swings.

### BRIEF DESCRIPTION OF THE SEVERAL VIEWS OF THE DRAWING

FIG. 1A is a perspective view showing the overall outer appearance of a barcode reading system having an optical scanning device according to a first embodiment of the present invention;

FIG. 1B is an exploded perspective view of the barcode reading system, showing the top cover removed and, thus illustrating the inner configuration of the system;

FIG. 1C is a perspective view of the system with its top cover removed, showing the inner configuration of the system as viewed from the back;

FIG. 2A is a perspective view showing the optical scanning device as obliquely viewed from above;

FIG. 2B is a perspective view showing the optical scanning device as obliquely viewed from above and back;

FIG. 2C is a top view of the optical scanning device;

FIG. 2D is a longitudinal sectional view of the optical scanning device, taken along line A-A shown in FIG. 2C;

FIG. 3 is a diagram depicting a configuration the flexible cable may have;

FIG. 4A is a top view of an optical scanning device according to a second embodiment of the present invention; and

FIG. 4B is a longitudinal sectional view of the optical scanning device shown in FIG. 4A, taken along line B-B shown in FIG. 4A.

### DETAILED DESCRIPTION OF THE INVENTION

Embodiments of the present invention will be described in detail, with reference to the accompanying drawings.

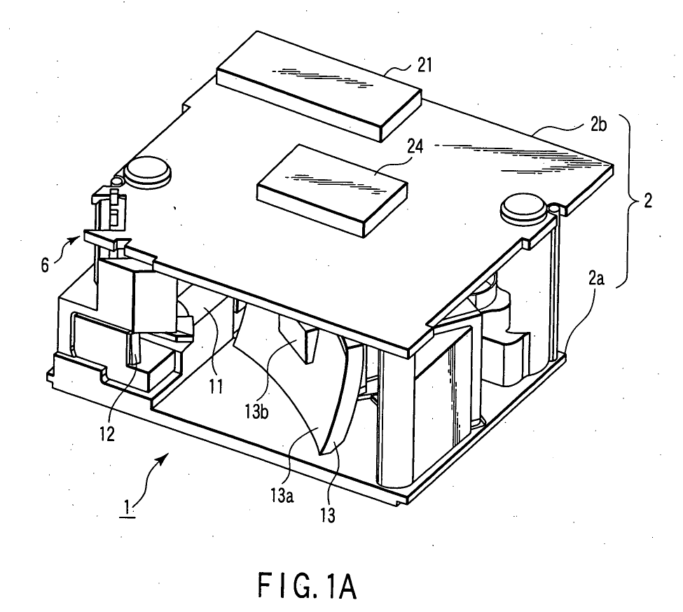

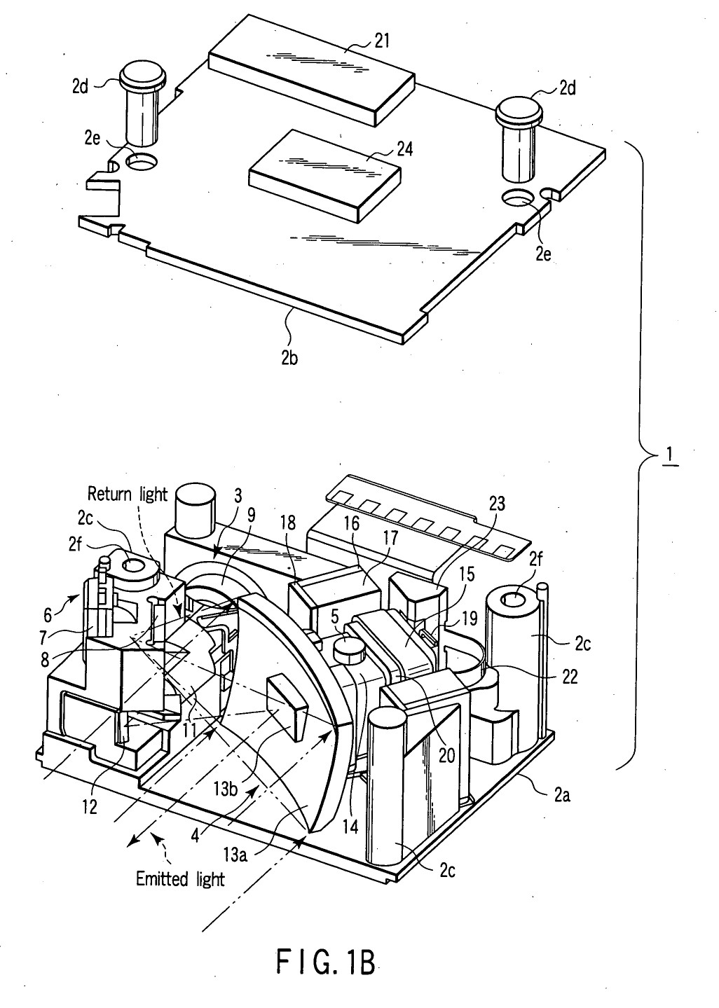

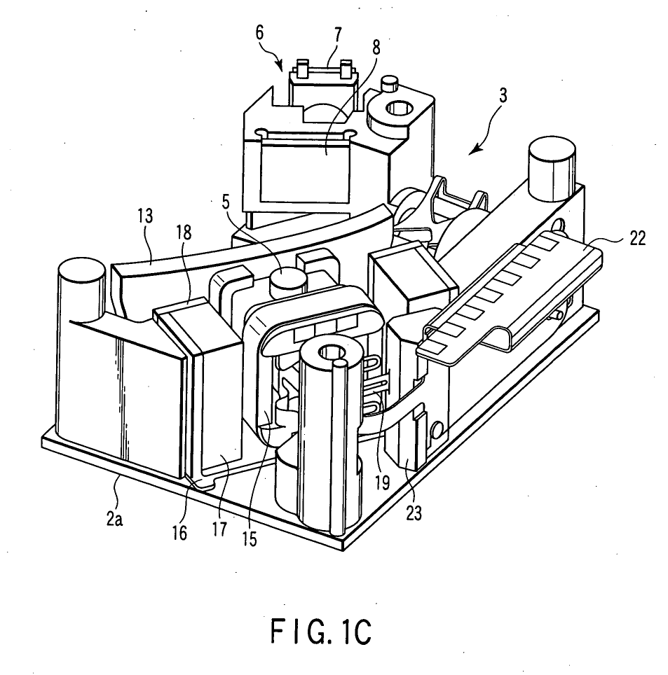

FIG. 1A is a perspective view showing the overall outer appearance of a barcode reading system having an optical scanning device according to a first embodiment of the present invention. FIG. 1B is an exploded perspective view of the barcode reading system, which shows the top cover removed and, thus illustrates the inner configuration of the system. FIG. 1C is a perspective view, showing the inner configuration of the system, as viewed from the back with the top cover removed.

In the present embodiment, the barcode reading system 1 is shaped like a rectangular parallelepiped and is, for example, about 21 mm wide, about 14 mm deep and about 11 mm high. The system 1 can be provided to have smaller dimensional values than the exemplified ones. That side of the barcode reading system 1, from which a light beam, such as a laser beam, is emitted and at which the beam reflected by an object is received, will be hereinafter referred to as “front surface” or “light-emitting/receiving side.”

As FIG. 1A shows, the barcode reading system 1 has a housing 2. The housing 2 comprises a chassis member 2a and a substrate unit 2b. The chassis member 2a is the base, while the substrate unit 2b is the top cover.

The chassis member 2a is shaped like a box or a frame, which has an opening in the front surface. Through the opening, a laser beam can be applied. The chassis member 2a supports, on the upper surface, various units and members, which will be described later. The lower surface of the chassis member 2a serves as installation surface for any external apparatus. The chassis member 2a is strong enough to overcome an impact it may receive when it falls onto the floor. It is composed of metal, for example, aluminum alloy. Alternatively, it may be made of alloy such as zinc die-cast metal or hard synthetic resin. Although not shown in FIG. 1A, all outer sides of the chassis member 2a, but the side having the opening, have covers that shield light, so that no stray light may enter the chassis member 2a from these sides. The opening may be covered with a transparent member.

As shown in FIGS. 1B and 1C, a light source unit 3, an optical scanning device 4, and an optical detecting unit 6, and a deflection mirror 12 are mounted, as major components, on the chassis member 2a. On the substrate unit 2b, a control unit 24 is mounted. The control unit 24 is constituted by a circuit board that includes various units (later described), control circuits for driving some components and signal-processing circuits for processing signals.

The substrate unit 2b has at least one hole (two holes, in the embodiment). The chassis member 2a has a support 2c, which has screw holes 2 cut in the top. The chassis member 2a and the substrate unit 2b are positioned, with the holes 2e aligned with the screw holes 2f, and are fastened to each other with screws 2d. The chassis member 2a and the substrate unit 2b may, of course, be fastened by any other appropriate method, such as hook-stopper fitting or adhesive bonding.

The light source unit 3 comprises a receptacle 11 and a deflection mirror 12. The receptacle 11 holds a laser diode (LD) 9, a collimator lens (not shown), and an LD diaphragm (not shown). The deflection mirror 12 deflects a laser beam, guiding the same to the optical scanning device 4. In the receptacle 11, the collimator lens changes a laser beam emitted from the laser diode 9, to a parallel light beam, and the LD diaphragm changes the parallel light beam to a beam having a small cross section of a desired spot size.

The laser diode 9 used in the present embodiment is, for example, the type widely used in DVD players and the like, which has a diameter of 5.6 mm and emits a beam having wavelength of 650 nm. Thus, the diode 9 can be very inexpensive, and can yet emit a very visible beam. The beam emitted from the laser diode 9 is changed to a parallel beam by the collimator lens. It changes to a beam having a desired spot size as it passes through the LD diaphragm. The beam output from the LD diaphragm is reflected by the deflection mirror 12 and applied to the plane mirror 13b of the scanning mirror 13, which is provided in the optical scanning device 4 as will be described later.

The optical detecting unit 6 comprises a received-light diaphragm unit (not shown), a band-pass filter 8, and a photodetector (PD) 7. The received-light diaphragm unit has a PD-field diaphragm that determines the field at which to receive the light first applied by the concave mirror 13a of the scanning mirror 13 and then reflected by a barcode. In the present embodiment, the optical detecting unit 6 is an independent unit and is provided on the deflection mirror 12 as shown in FIG. 1B.

The control unit 24 is mounted on the substrate unit 2b. The unit 24 includes signal-processing elements such as DSPs, and is an electronic circuit composed of electronic components that are mounted on a printed circuit board. The control unit 24 drives the units and components incorporated in the optical reading system and processes signals. More specifically, the control unit 24 drives, for example, the light source unit 3 and the optical scanning device 4, and converts an analog signal output from the optical detecting unit 6 to a binary signal that corresponds to the black-and-white pattern of a barcode. The binary signal is output to an external apparatus (i.e., data-processing apparatus) via an external output terminal 21.

In the barcode reading system 1, the scan laser beam emitted from the laser diode 9 travels along a path indicated by one-dot, dashed lines, and the light beam reflected by a barcode travels along a path indicated by a two-dot, dashed lines, as is illustrated in FIG. 1B. The laser beam emitted from the laser diode 9 is reflected by a barcode (not shown) and is applied, as returning beam to the concave mirror 13a of the scanning mirror 13. The concave mirror 13a condenses the returning beam, which is applied toward the photodetector 7. In front of the photodetector 7, the received-light diaphragm unit (not shown) and the band-pass filter 8 are arranged. The received-light diaphragm unit allows the passage of only the returning beam and shields the stray light coming in directions other than the axis of the concave mirror 13a. On the other hand, the band-pass filter 8 allows the passage of light having the same wavelength as the light emitted from the light source, and cuts off any light other than the signal light. Thus, the noise component, which is unnecessary, is removed, and only the signal component of the light is applied to the photodetector 7.

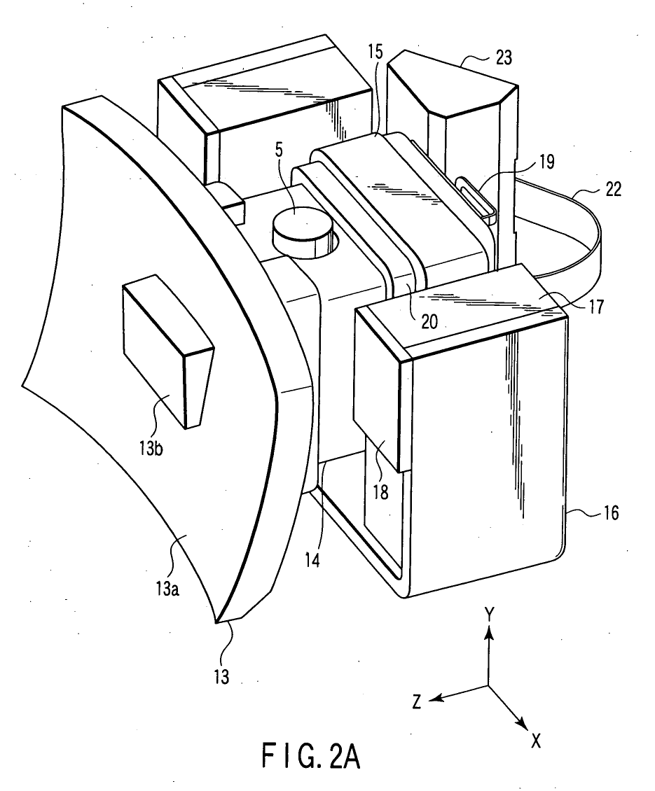

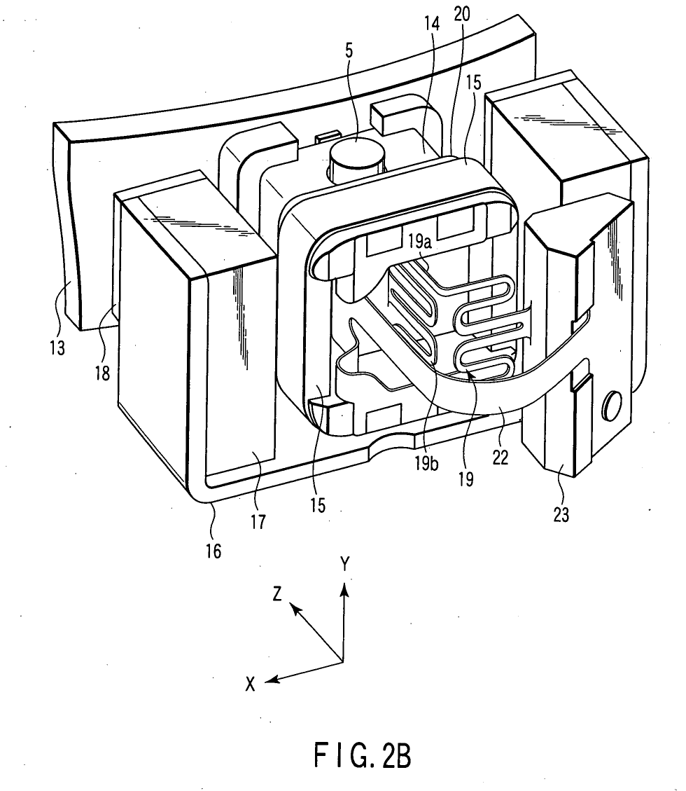

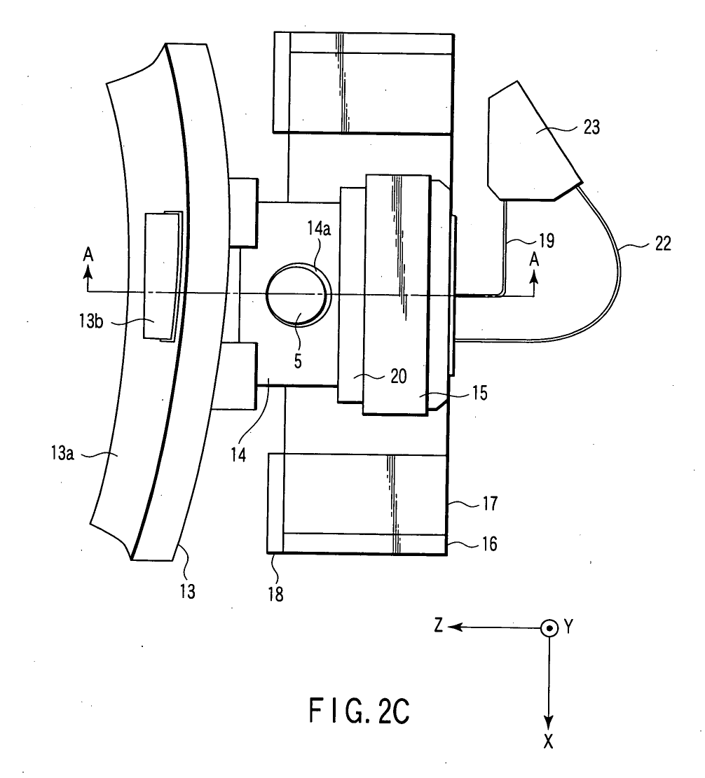

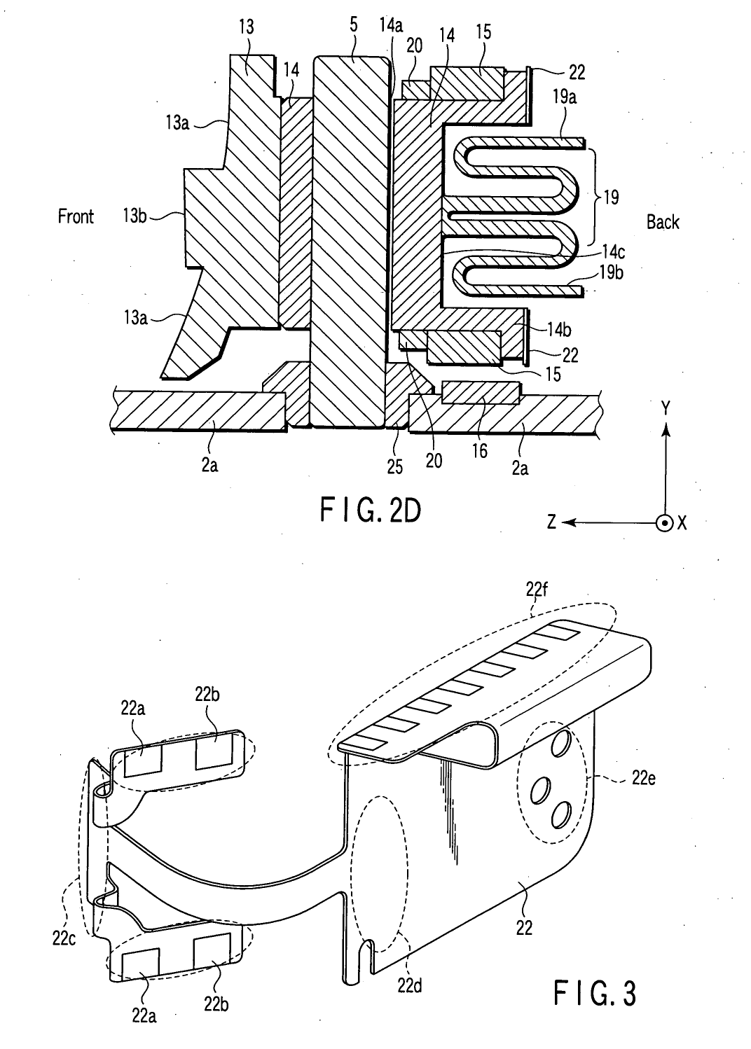

The optical scanning device 4 according to this embodiment will be described, with reference to FIGS. 2A to 2D. FIG. 2A is a perspective view showing the optical scanning device as obliquely viewed from the front and above. FIG. 2B is a perspective view showing the optical scanning device as obliquely viewed from the back and above. FIG. 2C is a top view of the optical scanning device. FIG. 2D is a longitudinal sectional view of the optical scanning device, taken along line A-A shown in FIG. 2C.

The optical scanning device 4 comprises a shaft 5, a scanning-mirror body 14, a drive coil 15, a detecting coil 20, two magnets 17, two U-shape yokes 16, a support spring 19, a support-spring member 23, and a flexible cable 22. The shaft 5, which is shaped like a column, is implanted on the chassis member 2a and fastened thereto by using a fastening member 25. The scanning-mirror body 14 has a bearing hole 14a, through which the shaft 5 extends. The scanning-mirror body 14 can therefore rotate around the shaft 5. The drive coil 15 and the detecting coil 20 are secured to the back of the scanning mirror body 14. The magnets 17 are arranged on the sides of the unit constituted by the drive coil 15 and the detecting coil 20, respectively, and generating a magnetic field applying magnetic fluxes to the drive coil 15 and the detecting coil 20. The U-shaped yokes 16 support the two magnets 17, respectively. The support spring 19 is attached, at one end, to the back of the scanning mirror body 14, and has a plurality of bend parts. The support-spring member 23 is implanted in the chassis member 2a. It holds the other end of the support spring 19. The flexible cable 22 electrically connects the drive coil 15, the detecting coil 20 and the control unit 24.

Of the components of the optical scanning device 4, the scanning mirror body 14 supports the concave mirror 13a holding the plane mirror 13b at the center and thus constitutes the scanning mirror 13. On the other hand, the drive coil 15, detecting coil 20, magnets 17 and yokes 16 constitute a scanning-mirror drive unit.

The shaft 5 may have a screw cut on the lower end and may set in screw engagement directly with the chassis member 2a. Alternatively, the shaft 5 may have a screw hole cut in the lower end and may be fastened directly to the chassis member 2a, by using screws. In either case, the fastening member 25 described above need not be used. Further, the shaft 5 may be fastened to the chassis member 2b by any other fastening method known in the art.

The bearing hole 14a has a diameter a little larger than the diameter of the shaft 5. Hence, the shaft 5 can smoothly rotate. In order to reduce the friction between the shaft 5 and the circumferential surface of the bearing hole 14a of the scanning mirror body 14, the shaft 5 or the circumferential surface, or both, may have a coating. For the same purpose, a lubricant such as oil or grease may be applied. If lubricant is applied, however, the interior of the optical scanning device 4 may become contaminated. In view of this, the device 4 should preferably be oil-free.

The scanning mirror 13 comprises the concave mirror 13a and the plane mirror 13b. The concave mirror 13a lies on the entire front. The plane mirror 13b is arranged at the center of the concave mirror 13a. A coupling member is provided on the back of the scanning mirror 13. The coupling member couples the scanning mirror 13 to the scanning mirror body 14.

A damper 18 is provided on the top part of the front of each magnet 17 (and of each yoke 16). The dampers 18 can absorb impact energy that may develop when an impact is applied, by accident, to the scanning mirror 13, swinging the mirror 13 so much that the mirror 13 may collide with the magnets 17. Thus, the dampers 18 can prevent the scanning mirror 13 from sustaining damage. The dampers 18 are made of elastic material, such as a rubber or gel-based one, which is soft and has a small coefficient of rebound.

The flexible cable 22 comprises a resin base and a wiring pattern (not shown) formed on the resin base. Through the wiring pattern, a drive signal is supplied from the control unit 24 to the drive coil 15, and a detection signal is supplied from the detecting coil 20 is supplied to the control unit 24.

As shown in FIG. 3, the flexible cable 22 is forked, at one end, into two fixed parts. On one fixed part, upper connecting electrodes 22a and 22b are provided at the back of the scanning mirror body 14. The other fixed part is secured to one side of the scanning mirror body 14. The connecting electrodes 22a are connected to the drive coil 15. The connecting electrodes 22b are connected the detecting coil 20. The flexible cable 22 has, at the other end, a fixed part and an LD-connecting part 22e. The fixed part is secured to the support-spring member 23. The LD-connecting part 22e has an electrode that is connected to the laser diode 9. The upper part of the other end of the flexible cable 22 is bent in the form of letter C. On the upper part, thus bent, connecting electrodes 22f are provided and are connected to the control unit 24.

The reflecting surfaces of the concave mirror 13a and plane mirror 13b of the scanning mirror 13 shown in FIG. 1B have coating formed by depositing gold so that they may have high reflectance. The scanning mirror 13 has been made by means of resin molding, forming the scanning mirror body 14, concave mirror 13a and plane mirror 13b integral with one another.

Each yoke 16 is secured, a U-shaped bottom, to the chassis member 2a. Two magnets 17 are attached to the opposing inner sides of the two vertical parts of the yoke 16, respectively. Thus, the magnets 17 face each other. Thus, a magnetic circuit is formed between these magnets. The magnetic circuit has a magnetic field that extends in one direction.

In the magnetic field of the magnetic circuit, the drive coil 15 and detecting coil 20 of the optical scanning device 4 are arranged, with a gap between them.

When a drive current (alternating current) flows through the drive coil 15, the two magnets 17 induce a force acting in the opposite z-axis direction, at those parts of the drive coil 15, which define two sides of the coil 15 and which extend across the magnetic gap between the two opposing magnets 17. The force acting in the opposite z-axis direction swings the scanning mirror body 14 back and forth around the shaft 5. As the detecting coil 20 swings back and forth in the magnetic circuit, an electromotive force is induced at both ends of the detecting coil 20. This electromotive force is a detection signal. The swing speed of the scanning mirror 13 can be inferred from the magnitude of the electric signal. On the basis of the electric signal, the control unit 24 can perform a minute feedback control on the swinging of the scanning mirror 13.

As shown in FIGS. 2B and 2D, the scanning mirror body 14 has a C-shaped part 14b on the back. The C-shaped part 14b has a recess that extends parallel to the direction in which the shaft 5 extends. The coil 15 and the detecting coil 20, both shaped like frame, are mounted on the outer circumferential surface of the C-shaped part 14b.

To the bottom 14c (i.e., deepest plane) of the recess made in the C-shaped part 14b, the above-mentioned support spring 19 is secured, at one end. The support spring 19 vertically extends from the bottom 14c is bent at a part exposed outside the C-shaped part 14b, and is therefore like the letter L. The other end of the support spring 19 is fixed to the support-spring member 23.

The support spring 19 is composed of a pair of leaf springs 19a and 19b, each having a plurality of bend parts that are symmetrical to those of the other leaf spring. The bent parts of the leaf springs 19a are connected at upper end, forming an S-shaped member that is symmetrical with respect to a line, and are coupled, at the other end, to the bottom 14c of the scanning mirror body 14 and to the support-spring member 23, respectively. As described above, the upper end of either bent part is bent by 90°. The other leaf spring 19b is shaped in the same way as the leaf spring 19a and symmetrically shaped to the leaf spring 19a with respect to a line intersecting at right angles with the direction in which the shaft 5 extends.

In the present embodiment, the leaf springs 19a and 19b are connected at the other end, constituting the support spring 19. The support spring 19 is therefore coupled to the bottom 14c of the scanning mirror body 14 and the support-spring member 23. The support spring 19 is manufactured as an integral insert member so that it may be stretched between the scanning mirror body 14 and the support-spring member 23.

The support spring 19 has been manufactured by etching or pressing a thin plate of metal desirable as spring material, such as beryllium copper for springs, stainless steel for springs, titanium alloy for springs or nickel-titanium alloy. The support spring 19 used in this embodiment may be composed of one metal plate. Alternatively, it may be composed of two or more thin metal plates of various materials having different spring coefficients. In this case, the materials are selected in accordance with their spring coefficients so that the support spring 19 may be adjusted in sprinting coefficient and rigidity. Further, the distance the metal plates overlap one another may be adjusted so that the scanning mirror may swing evenly to the left and the right.

The two leaf springs 19a and 19b, which constitute the support spring 19, are so arranged that their surfaces extend vertically (in the direction of gravity). In other words, the leaf springs 19a and 19b lie parallel to the plane in which the shaft 5 extends. So arranged, the leaf springs 19a and 19b have a rectangular cross section the long sides of which extend along the shaft 5. Thus, the support spring 19 has a rectangular cross section whose long sides extends along the axis of the shaft 5, and therefore exhibits high rigidity along an axis (of the shaft 5) around which the scanning mirror 13 swings.

As described above, the support spring 19 is rigid along the axis of the shaft 5 extending parallel to the plane of both leaf springs 19a and 19b. The scanning mirror 13 secured to the free end of the support spring 19 can therefore be held at a prescribed level (or height) along the shaft 5 and can be inhibited from moving up or down along the shaft 5. The movable components, such as the scanning mirror 13 and the scanning mirror body 14 (rotor), are therefore supported, as if floating from the chassis member 2a. Hence, no thrust friction develops between the movable components and the chassis member 2a.

Shaped like letter L, the support spring 19 biases the scanning mirror body 14 a little toward the back, keeping the shaft 5 always in contact with the front part of the circumferential surface of the bearing hole 14a as is illustrated in FIG. 2C. Note that the scanning mirror body 14 will not smoothly rotate if no gap is provided between the shaft 5 and the circumferential surface of the hole 14a. Also, note that if such a gap is provided, the axis around which the scanning mirror body 14 swings will shift. In order to prevent this shift the axis, the support spring 19 pulls the scanning mirror body 14 backward a little, as described above.

Assume that either the shaft 5 or the circumferential surface of the bearing hole 14a wears because the scanning mirror 13 has repeatedly swung over the long use of the barcode reading system 1. Then, the gap between the shaft 5 and the circumferential surface of the hole 14a may grow, possibly causing the scanning mirror body 14 to vibrate, failing to swing as stably as desired. Even in such a case, the scanning mirror body 14 can swing stably, because the bias of the support spring 19 keeps the body 14 in contact with the shaft 5. The bias of the support spring 19 also serves to hold the scanning mirror 13 at the neutral position (i.e., the position the mirror 13 takes while not swinging).

A coil spring having low rigidity along the shaft may be used to prevent a mirror from moving (or swinging) along the shaft, as disclosed in Jpn. Pat. Appln. KOKAI Publication No. 2003-315722. In this case, the bias of the coil spring must be increased to enhance the friction between the shaft and the bearing, thereby to prevent the mirror from moving up and down. The increase in the friction will result in a loss of drive power, however. Thus, an increase in the bias for eliminating the thrust friction and a decrease in the sliding friction can hardly be achieved at the same time. In view of this, it is not advisable to use a coil spring.

The support spring 19 is curved twice as it extends from the end connected to the scanning mirror 13 to the bent part. These curved parts of the support spring 19 are resilient, allowing the scanning mirror 13 to swing around the shaft 5.

In the optical scanning device 4 according to the present embodiment, the support spring 19 restricts the motion the scanning mirror body 14 makes along the shaft 5 holding the body 14, and biases the scanning mirror body 14, keeping the body 14 in contact with the shaft and yet allowing the body 14 to swing. Thus, the axis around which the scanning mirror body 14 swings can be prevented from shifting.

The support spring 19 is composed of two leaf springs, each bent in the form of letter S. The support spring 19 thus composed is bent, at middle part, in the form of letter L. Thus, the spring 19 has two independently working components, one dominantly biasing the scanning mirror body 14, while the other dominantly swinging the scanning mirror body 14. The body 14 can therefore be biased optimally and can be swung optimally. In addition, the distance from the scanning mirror 13 to the support-spring member 23 (as measured along a straight line) can be short, saving the installation space.

With reference to FIGS. 1A to 1C, it will be described how the optical scanning device 4 according to the present embodiment emits a laser beam and reads barcode data if it is incorporated in the barcode reading system 1.

The laser diode 9 emits a laser beam, which the collimator lens changes to a parallel beam. The LD diaphragm changes the parallel beam to a beam having a desired small cross section. The beam is applied to the deflection mirror 12. The deflection mirror 12 reflects the beam, which is applied to the optical scanning device 4.

In the optical scanning device 4, drive pulses are applied via the flexible cable 22 to the drive coil 15. Exposed to the magnetic fluxes emanating from the magnets 17, the drive coil 15 generates an electromagnetic force. The electromagnetic force makes the scanning mirror 13 reliably swing around the shaft 5, against the bias of the support spring 19 (i.e., bias applied to hold the mirror 19 at the neutral position). Meanwhile, the detecting coil 20, formed integral with the drive coil 15, rotates in the magnetic field composed of the magnetic fluxes. An electromotive force is therefore induced across the detecting coil 20. A detection signal is therefore generated and supplied via the flexible cable 22 to the control unit 24. The control unit 24 performs a high-precision feedback control on the swing of the scanning mirror 13.

The laser beam coming from the deflection mirror 12 is thus applied to the plane mirror 13b of the scanning mirror 13 that is swinging back and forth. The laser beam, or a scanning laser beam rotated back and forth through a prescribed angle, is applied to a barcode located in front of the barcode reading system 1, forming a straight locus on the barcode.

The laser beam thus applied forms a light spot on the barcode, which moves back and forth. The barcode reflects the laser beam and is applied to the concave mirror 13a, as returning beam. The concave mirror 13a condenses the returning beam. The beam condensed passes through the PD-field diaphragm and then through the band-pass filter 8. The returning beam is applied to the photodetector 7. The photodetector 7 converts the returning beam to an electric signal, or a barcode signal.

The optical scanning device 4 according to this embodiment may be used in an optical symbol reading system such as a barcode reader, as described above. Then, the optical scanning device 4 can reliably scan barcodes with a stable laser beam. This ensures accurate data reading from the barcodes. Being small and simple in structure, the optical scanning device 4 can help to reduce the size and weight of the barcode reader.

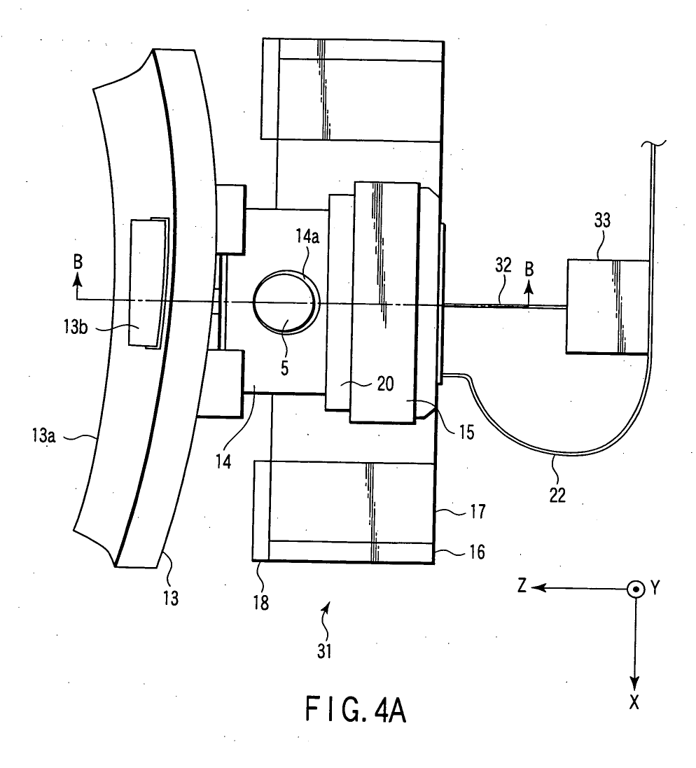

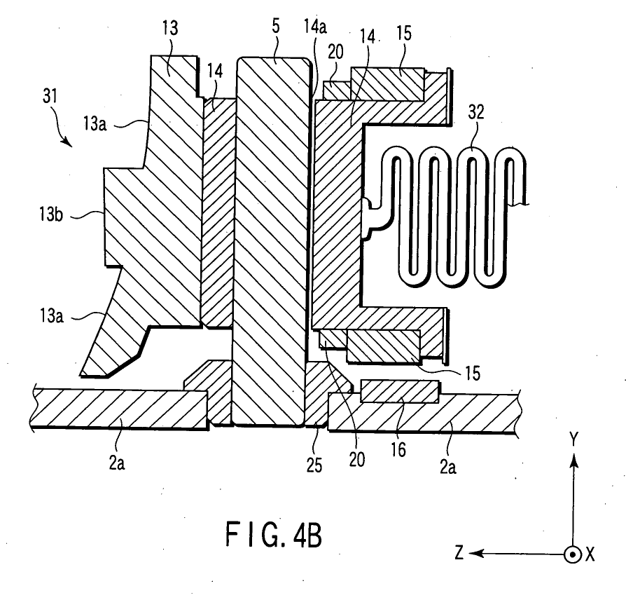

A second embodiment of the present invention will be described, with reference to FIGS. 4A and 4B.

FIG. 4A is a top view of an optical scanning device 31 according to a second embodiment of the present invention. FIG. 4B is a longitudinal sectional view of the optical scanning device 31, taken along line B-B shown in FIG. 4A.

The optical scanning device 31 according to this embodiment differs from the device 4 according to the first embodiment, in the shape of the support spring. The components, except the support spring and the member holding the support spring, are identical to those of the first embodiment. Therefore, the components identical to those of the first embodiment are designated by the same reference numbers and will not be described.

As FIGS. 4A and 4B show, the support spring 32 used in the optical scanning device 31 is a leaf spring that is flat and meandering. The leaf spring 32 is secured, at one end, to the bottom 14c of the recess made in the scanning mirror body 14. The other end of the support spring 32 is fastened to a support-spring holding member 33, which is implanted in the chassis member 2a.

The support spring 32 is made of the same metal and has been manufactured in the same way as the support spring 19 used in the first embodiment. The support spring 32 is provided as an integral insert member integrally formed with the scanning mirror body 14 and the support-spring member 23.

The second embodiment can achieve the same advantages as the first embodiment. The support spring 32 is held by the support-spring holding member 33, at a position different from the support spring 19 in terms of position. The optical scanning device 31 according to the second embodiment is deeper than, but is less wide than, the optical scanning device 4 according to the first embodiment. Hence, either the optical scanning device 4 or the optical scanning device 31 can be selected and used in an optical symbol reading system, in accordance with the configuration of the optical symbol reading system. The support spring 32 of the second embodiment can be formed, merely by etching or pressing a thin metal plate, without the necessity of being bent. The support spring 32 can therefore be manufactured at lower cost than the support spring 19.

As has been described, the present invention can provide an optical scanning device which can be small and light and can be manufactured at low cost and in which unnecessary motion is eliminated when the mirror swings, thereby stably and reliably scanning an object with a laser beam, and can also provide an optical reading system that incorporates such an optical scanning device.

What is claimed is:

1. An optical scanning device having:
a scanning mirror which has a plane mirror configured to reflect an incident light beam and direct the light beam toward an object existing in front of the device, and a concave mirror configured to receive and condense the light beam reflected by the object;
a scanning mirror body which holds the scanning mirror and which is mounted on a shaft implanted in a base;
a drive mechanism which swings the scanning mirror body around the shaft; and
a support spring which is secured, at one end, to a back of the scanning mirror body and, at the other end, to a fastening member implanted in the base and which has a plurality of bent parts, each shaped like a plate and having a surface intersecting at right angles with a direction in which the scanning mirror body swings.

2. The optical scanning device according to claim 1, wherein the support spring is L-shaped, having a part bent to a direction intersecting at right angles with the direction in which the scanning mirror body swings.

3. The optical scanning device according to claim 2, wherein the support spring is composed of a first leaf spring and a second leaf spring which have shapes symmetrical with respect to the direction to which the bend part is bent, and the first and second leaf springs are shaped like letter S and symmetrical with respect to the bent part and inhibit the scanning mirror body from moving in the direction intersecting at right angles with the direction in which the scanning mirror body swings.

4. The optical scanning device according to claim 2, wherein the scanning mirror body has a hole, the shaft extends through the hole, supporting the scanning mirror body, and the support spring biases the scanning mirror body backwards and causes, by virtue of the L-shape, the scanning mirror body to abut on a front part of the shaft, thereby providing a gap at a rear part of the hole and restricts a motion of the an axis around which the scanning mirror body swings.

5. The optical scanning device according to claim 1, wherein the support spring is meandering in a direction that intersects at right angles with the direction in which the scanning mirror body swings.

6. The optical scanning device according to claim 1, wherein the plane mirror is arranged at a center of the concave mirror, whereby the direction in which the light beam is emitted from the plane mirror coincides with the direction in which the light beam reflected by the object is applied to the concave mirror.

7. The optical scanning device according to claim 1, wherein the support spring is a leaf spring made of at least one element selected from the group consisting of beryllium copper for springs, stainless steel for springs, titanium alloy for springs or nickel-titanium alloy.

8. The optical scanning device according to claim 1, which further has a drive coil provided on the scanning mirror body and a plurality of magnets secured on the base and located in the vicinity of the drive coil, and in which a magnetic field acting between the drive coil and the magnets swings the scanning mirror body, while the support spring is biasing the scanning mirror body.

9. The optical scanning device according to claim 8, which further has a detecting coil provided on the scanning mirror body and a control unit configured to control a drive signal to be supplied to the drive coil, and in which the detecting coil detects a swing state of the scanning mirror body, generates a signal representing the swing state and supplies the signal to the control unit, and the control unit performs a feedback control based on the signal, thereby adjusting the swing state.

10. The optical scanning device according to claim 8, wherein the drive mechanism has dampers provided on those sides of the magnets, which face the scanning mirror, the dampers being configured to absorb impact energy that may develop when an impact is applied to the scanning mirror.

11. An optical reading system comprising:
a light source which emits a light beam;
a deflecting mirror which deflects the light beam emitted from the light source;
an optical scanning device which keeps swinging and directing the light toward an object, thereby scanning the object with the light beam, and which receives and condenses the light beam reflected by the object; and
an optical detecting unit which receives the reflected light condensed by the optical scanning device,
the optical scanning device having:
a scanning mirror which has a plane mirror configured to reflect an incident light beam and direct the light beam toward an object existing in front of the device, and a concave mirror configured to receive and condense the light beam reflected by the object;
a scanning mirror body which holds the scanning mirror and which is mounted on a shaft implanted in a base;
a drive mechanism which swings the scanning mirror body around the shaft; and
a support spring which is secured, at one end, to a back of the scanning mirror body and, at the other end, to a fastening member implanted in the base and which has a plurality of bent parts, each shaped like a plate and having a surface intersecting at right angles with a direction in which the scanning mirror body swings.

12. The optical reading system according to claim 11, wherein the support spring is L-shaped, having a part bent to a direction intersecting at right angles with the direction in which the scanning mirror body swings.

13. The optical reading system according to claim 12, wherein the support spring is composed of a first leaf spring and a second leaf spring which have shapes symmetrical with respect to the direction to which the bend part is bent, and the first and second leaf springs are shaped like letter S and symmetrical with respect to the bent part and inhibit the scanning mirror body from moving in the direction intersecting at right angles with the direction in which the scanning mirror body swings.

14. The optical reading system according to claim 12, wherein the scanning mirror body has a hole, the shaft extends through the hole, supporting the scanning mirror body, and the support spring biases the scanning mirror body backwards and causes, by virtue of the L-shape, the scanning mirror body to abut on a front part of the shaft, thereby providing a gap at a rear part of the hole and restricts a motion of the an axis around which the scanning mirror body swings.

15. The optical reading system according to claim 11, wherein the support spring is meandering in a direction that intersects at right angles with the direction in which the scanning mirror body swings.

16. The optical reading system according to claim 11, wherein the plane mirror is arranged at a center of the concave mirror, whereby the direction in which the light beam is emitted from the plane mirror coincides with the direction in which the light beam reflected by the object is applied to the concave mirror.

17. The optical reading system according to claim 11, wherein the support spring is a leaf spring made of at least one element selected from the group consisting of beryllium copper for springs, stainless steel for springs, titanium alloy for springs or nickel-titanium alloy.

18. The optical reading system according to claim 11, which further has a drive coil provided on the scanning mirror body and a plurality of magnets secured on the base and located in the vicinity of the drive coil, and in which a magnetic field acting between the drive coil and the magnets swings the scanning mirror body, while the support spring is biasing the scanning mirror body.

19. The optical reading system according to claim 18, which further has a detecting coil provided on the scanning mirror body and a control unit configured to control a drive signal to be supplied to the drive coil, and in which the detecting coil detects a swing state of the scanning mirror body, generates a signal representing the swing state and supplies the signal to the control unit, and the control unit performs a feedback control based on the signal, thereby adjusting the swing state.

20. An optical reading system having:
a light source which emits a laser beam;
a plane mirror which reflects the laser beam emitted from the light source, directing the laser beam toward an object;
a support spring which is secured at one end to the plane mirror and at the other end to a fastening member;
a drive mechanism which swings the plane mirror around a shaft; and
a photodetector which receives a light reflected from the object,
the support spring having a leaf-spring part arranged in a plane that intersects at right angles with a direction in which the scanning mirror swings, having a rectangular cross section whose long sides extend parallel to the shaft around which the scanning mirror swings, and being bent several times in that plane.
